(19) United States
(12) Patent Application Publication
(10) Pub. No.: US 2014/0362673 A1
(43) Pub. Date: Dec. 11, 2014

(54) WATCH WITH ENCLOSED CROWN

(71) Applicant: David EARL, San Francisco, CA (US)

(72) Inventor: David EARL, San Francisco, CA (US)

(21) Appl. No.: 14/301,251

(22) Filed: Jun. 10, 2014

Related U.S. Application Data
(60) Provisional application No. 61/833,856, filed on Jun. 11, 2013.

(51) Int. Cl. G04B 3/04; G04B 37/08

(52) U.S. Cl. CPC G04B 3/043; G04B 37/082
USPC 368/194; 368/288; 368/289; 368/232

(57) ABSTRACT

A watch for keeping time that comprises a watchcase for housing the movement, the stem, and the crown. The watchcase comprises a lid having a crystal and a body configured to mate with the lid, the body comprising a floor that supports the movement and a wall surrounding the floor, wherein the wall has a notch into which the crown protrudes and wherein the watchcase formed by mating the lid with the body encloses the movement, the stem, and the crown on all sides. A method for setting the time on a watch with an enclosed crown.

### CROSS REFERENCE TO RELATED APPLICATIONS

This application claims priority to provisional application No. 61/833,856 filed Jun. 11, 2013, which is hereby incorporated by reference in its entirety.

### BACKGROUND

1. Field

The present disclosure relates generally to watches, and more specifically to a watch having a watchcase that encloses a movement, a stem, and a crown.

2. Description of Related Art

On an analog watch, the crown and stem of the watch are used to wind the movement (for mechanical watches) and to change the position of the hands to set the time. One end of the stem is attached to the movement, and the other end of the stem is attached to the crown. Typically, to set the time, the stem and crown must be extended outwards from the watchcase prior to rotation in order to disengage the hands from the movement.

For most people, the stem and crown are rarely needed. The time is infrequently reset and today, relatively few watches require winding. Even so, the crown is typically readily accessible, allowing the crown (and stem) to be easily extended from the watchcase.

This accessibility comes at a price. The crown may be inadvertently extended, thus stopping the watch and potentially moving the hands into an incorrect position. An extended stem is at risk for breakage, because it is thin and delicate. Furthermore, the opening through which the stem and crown protrude provides a path for water to enter the watchcase and potentially damage the movement.

To address the latter concern, current water-resistant watches may use a screw-down crown that screws into the watchcase, thus reducing susceptibility to water encroachment. To set the time, the screw-down crown must typically first be unscrewed from the watchcase, then pulled out and operated as normal. However, this approach still leaves the crown partially exposed, and may require seals or gaskets around the crown to prevent water incursion. An alternative approach is described below in which the entire stem and crown are enclosed with the movement within the watchcase.

### BRIEF SUMMARY

This disclosure describes a watch for keeping time that comprises a watchcase for housing a movement, a stem, and a crown. The watchcase comprises a lid having a crystal and a body configured to mate with the lid, the body comprising a floor that supports the movement and a wall surrounding the floor, wherein the wall has a notch into which the crown protrudes and wherein the watchcase formed by mating the lid with the body encloses the movement, the stem, and the crown on all sides. In some embodiments, the body and the lid are threaded to enable them to be screwed together to form a water-resistant enclosure around the movement, the stem, and the crown. In some embodiments, the watch comprises a dial with an opening to allow access to the crown while the dial, movement, stem, and crown are installed in the body. In some embodiments, the threads on the watchcase are located above and/or below the level of the movement of the watch to enable the same design to be used for a watch with an enclosed crown and a watch with an exposed crown.

A method is provided for setting the time on a watch with an enclosed crown having a watchcase comprising a body and a lid, where the body and lid are threaded to enable them to be mated together. The method comprises unscrewing the body and lid from each other and accessing the crown through an opening in the dial. The crown is moved away from the movement to extend the crown and stem to disengage the hands from the movement, and the crown is rotated to set the position of the hands. In some embodiments, the crown is accessed from the back side of the dial. The crown is then moved back towards the movement to re-engage the hands with the movement. The body and lid are screwed back together to form a water-resistant enclosure around the movement, the stem, and the crown.

### DESCRIPTION OF THE FIGURES

FIG. 1 depicts a body of an exemplary watchcase that encloses a movement, a stem, and a crown.

FIG. 2 depicts a body of an exemplary watchcase that encloses a movement, a stem, and a crown.

FIG. 3 depicts a lid of an exemplary watchcase that encloses a movement, a stem, and a crown.

FIG. 4A depicts a lid of an exemplary watchcase that encloses a movement, a stem, and a crown.

FIG. 4B depicts a lid of an exemplary watchcase that encloses a movement, a stem, and a crown.

FIG. 5A depicts a body of an exemplary watchcase that encloses a movement, a stem, and a crown.

FIG. 5B depicts a body of an exemplary watchcase that encloses a movement, a stem, and a crown.

FIG. 6 depicts an exemplary watchcase lid and body, with the body containing a movement, a stem, and a crown.

FIG. 7 depicts an exemplary watchcase body assembled with a movement, stem, crown, and dial.

FIG. 8 depicts an exemplary watchcase body with a D-shaped opening for a peg on a movement and an opening for a strap or other attachment.

FIG. 9 depicts a dial for use with a watch that encloses a movement, a stem, and a crown.

FIG. 10 depicts an exemplary watchcase body with threads located above and below the level of the movement.

FIG. 11 depicts an exemplary watchcase back piece for use with a threaded watchcase body.

FIG. 12 depicts an exemplary watchcase body with threads located above and below the level of the movement.

FIG. 13 depicts an exemplary watchcase body with threads located above the level of the movement.

FIG. 14 depicts an exemplary watchcase body with threads located above the level of the movement.

FIG. 15 depicts an exemplary watchcase lid for use with a threaded watchcase body.

FIG. 16 depicts an exemplary watchcase body with internal threads located above and below the level of the movement.

FIG. 17 depicts an exemplary watchcase body with threads located above and below the level of the movement.

FIG. 18 depicts an exemplary watchcase body with threads located above and below the level of the movement, with an opening in the wall through which a stem and crown may protrude.

FIG. 19 depicts an exemplary watchcase body, watchcase lid, and watchcase back piece.

FIG. 20 depicts a dial for use with a watch that encloses a movement, a stem, and a crown.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

Various embodiments are described below, relating to a watch having a watchcase that encloses a movement, a stem, and a crown. In some embodiments, the watchcase comprises a body and a lid that are configured to mate together to form an enclosure for the movement, stem, and crown. In some embodiments, the watchcase comprises a body, a lid, and a back piece that are configured to mate together to form an enclosure for the movement, stem, and crown.

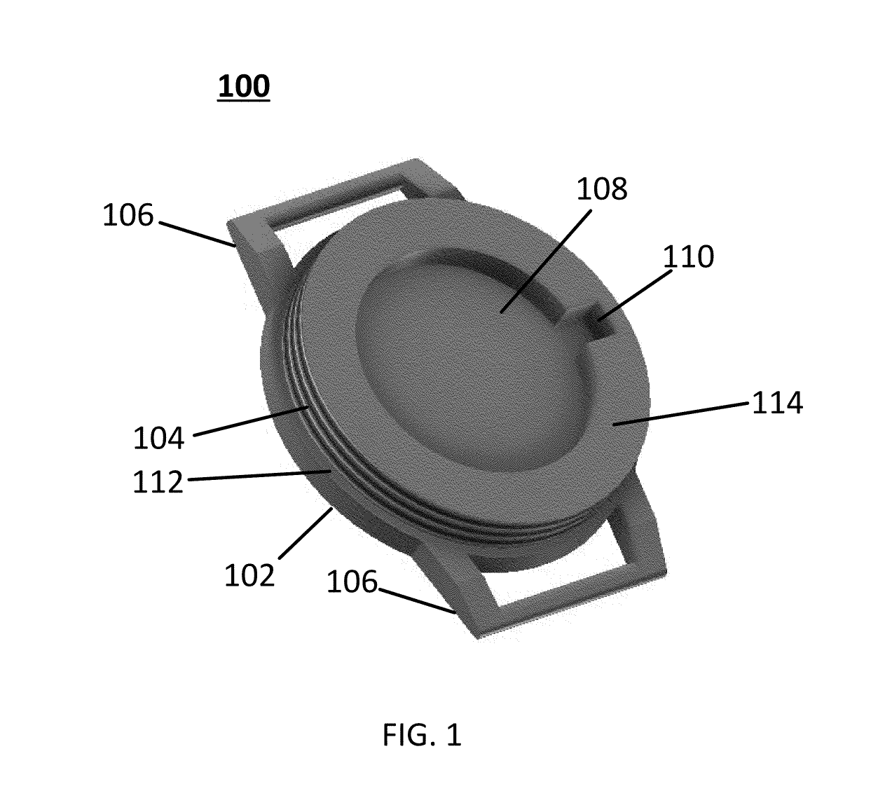

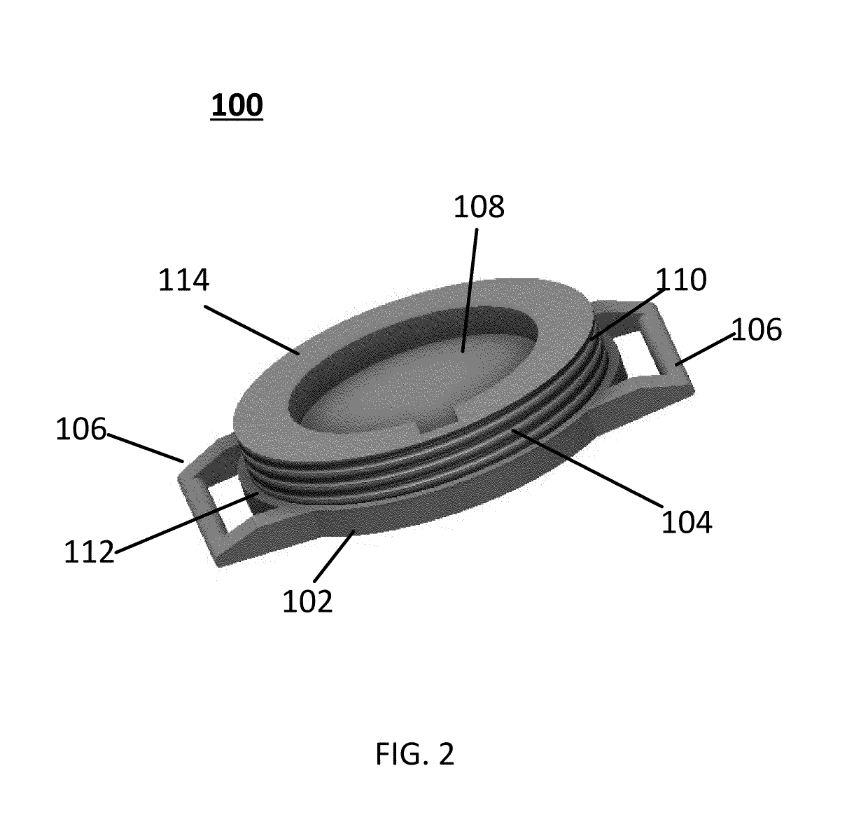

FIGS. 1-2 depict an exemplary body 100 of a watchcase for a watch that encloses a movement, a stem, and a crown. The body 100 is configured to accommodate a movement, a stem, and a crown. With respect to FIG. 1, the body 100 includes a base 102 that forms the back of the watchcase. On a wrist watch, the base 102 rests against the wrist of the wearer. In exemplary body 100, the base 102 is circular. In alternative embodiments, the base 102 may be oval, square, or rectangular, for example.

The body 100 has a floor 108 on which the movement may rest when it is installed inside the watchcase. The floor 108 is surrounded by a cylindrical wall 104 with a diameter that is somewhat smaller than the diameter of the base 102, thus leaving a ledge 112 between the cylindrical wall 104 and the perimeter of the base 102. In alternative embodiments, the wall 104 may be flush with the perimeter of the base 102 such that there is no ledge 112. In some embodiments, the wall 104 may not be cylindrical. For example, if the base is rectangular, the wall may also be rectangularly shaped.

In exemplary body 100, the wall 104 has exterior threads to enable the body 100 to be screwed together with a lid to form a watchcase. In alternative embodiments, the wall 104 may have interior threads. In some alternative embodiments, the wall may not have threads at all; for example, if the body and the lid are configured to mate together by snapping in place or by using small screws.

The wall 104 has a notch 110 into which the crown protrudes when the movement, the stem, and the crown are installed in the watchcase. In exemplary body 100, the notch 110 surrounds the crown on three sides. The notch 110 thereby engages with the crown to inhibit the movement from rotating around the plane of the floor 108 within the watchcase. In some embodiments, the height of the floor 108 is designed such that when the movement is installed, the stem and crown extend horizontally from the movement into the notch 110. This configuration may allow the movement to be installed within the watchcase without requiring the use of spacers.

The notch 110 is configured to allow the crown and stem to be fully extended while the movement, stem, and crown are installed in the body 100.

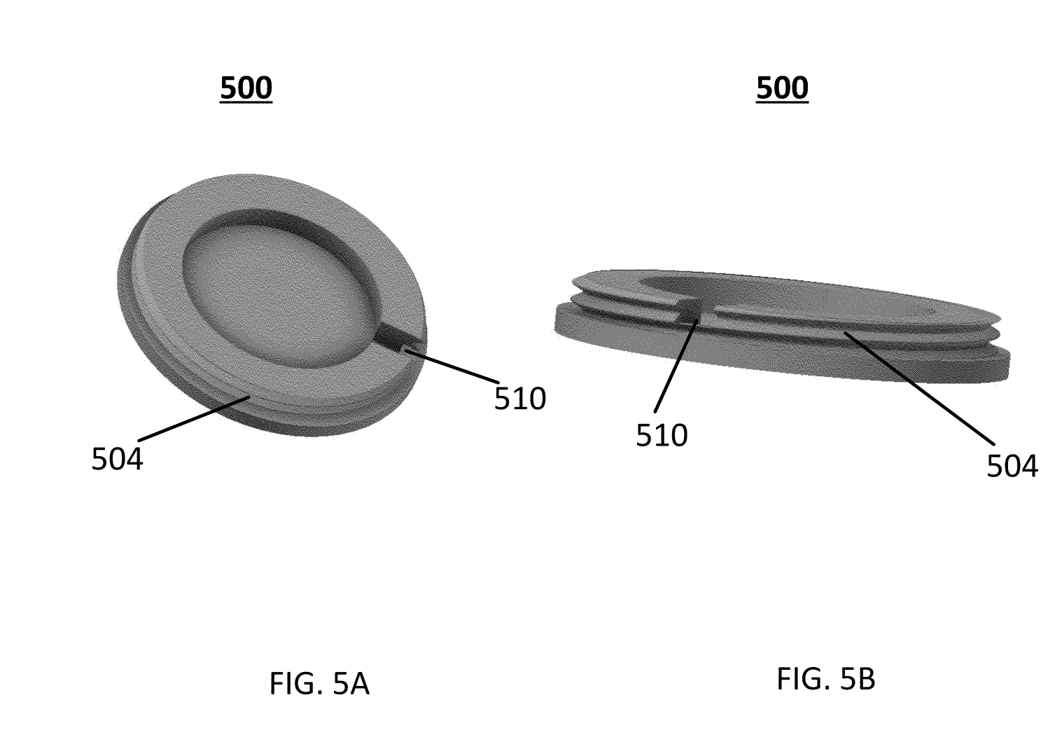

In exemplary body 100, the notch 110 is rectangular. In other embodiments, it may be a different shape; for example, the notch 110 may be semi-circular. In some embodiments, the notch 110 may extend through at least a portion of the wall 104 to form an opening. FIGS. 5A-5B depict exemplary body 500, in which a notch 510 extends through a portion of a wall 504.

The wall 104 has a flat upper surface 114 that is configured to be flush with the surface of the corresponding lid when the lid and the body 100 are screwed together. The height of the wall 104 is less than the diameter of the crown such that a portion of the installed crown is accessible above the wall 104, thereby enabling the crown to be accessed while installed in the body 100. As previously discussed, the notch 110 is sufficiently long to allow the crown and stem to be fully extended while installed in the body 100; that is, the movement, stem, and crown need not be removed from the body 100 to set the time or wind the watch.

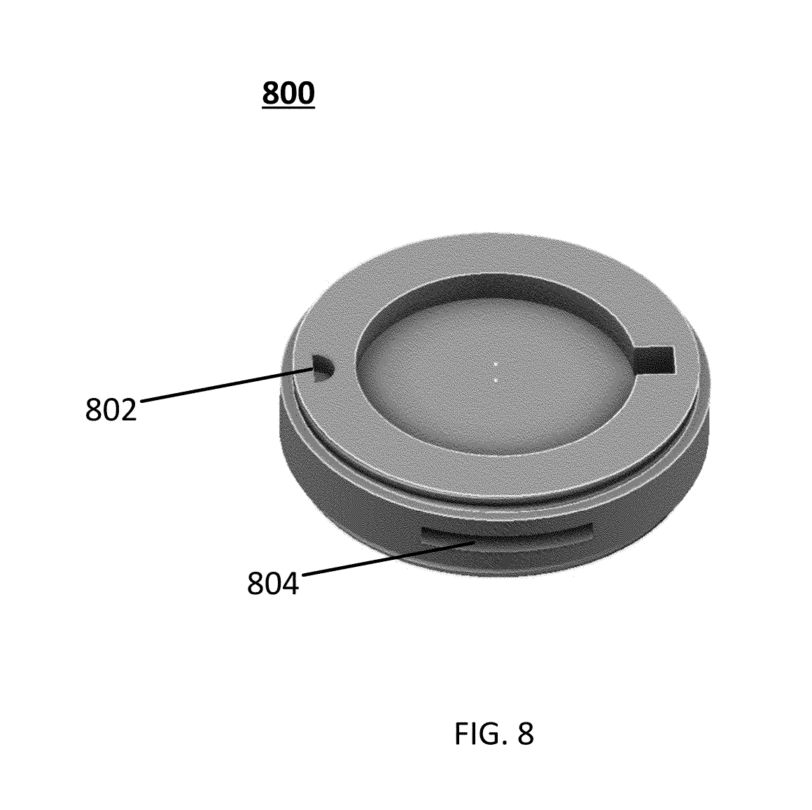

The body 100 includes two lugs 106 attached to the base 102. The lugs 106 are used to attach straps or other attachments to the body 100. In some embodiments, the body 100 may not include lugs; for example, if the body 100 is intended for use with a pocket watch. In some embodiments, the body 100 may have an opening that allows a strap to be inserted through the openings instead of attaching straps to lugs 106. For example, FIG. 8 depicts a watchcase with an opening 804 that penetrates through the body and allows a strap or other attachment to be threaded through the body.

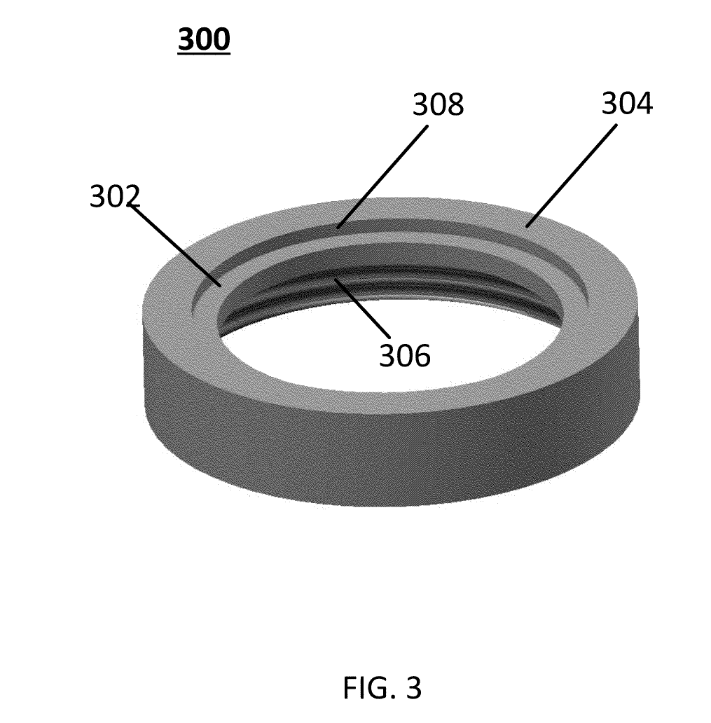

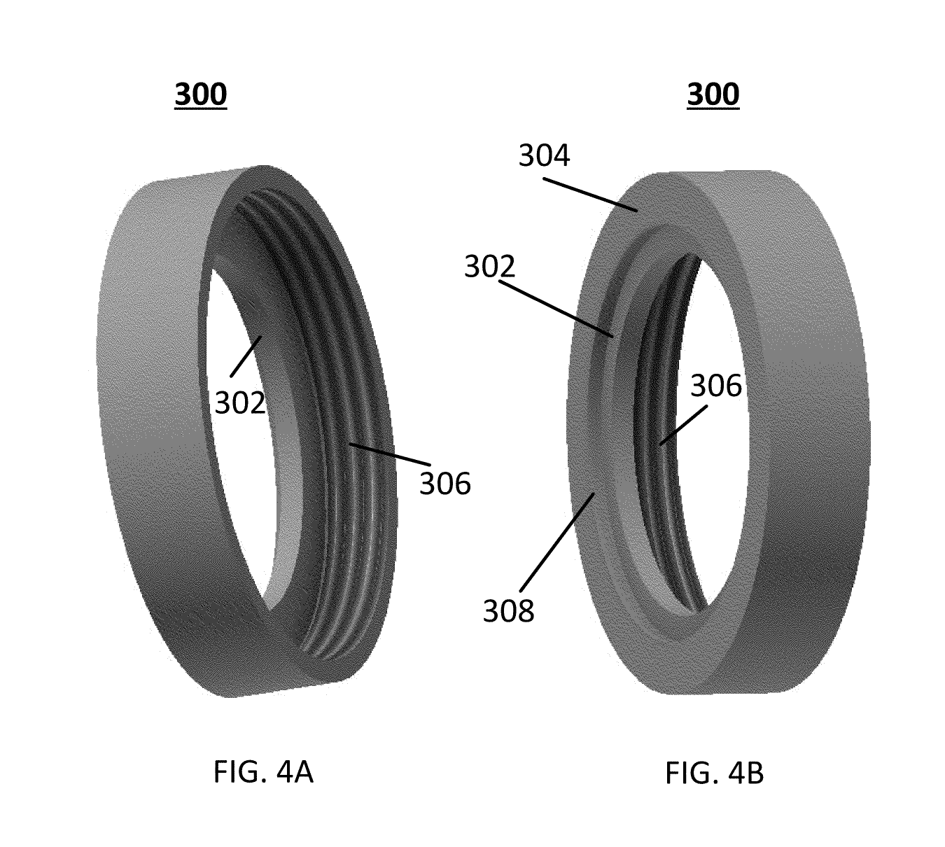

FIG. 3 and FIGS. 4A-B depict an exemplary lid 300 of a watchcase for a watch that encloses a movement, a stem, and a crown. With respect to FIG. 3, the lid 300 is cylindrically shaped with a top surface 304. The lid 300 has an interior flat surface 308 and an interior ledge 302 that are configured to accept a crystal. In exemplary lid 300, the crystal may be shaped such that it fits snugly within the interior flat surface 308 and rests on the inner ledge 302. The crystal may be installed in the lid 300 and held in place using an adhesive, for example. In some embodiments, the crystal and the lid 300 may be fabricated from a single material, as a single piece.

Exemplary lid 300 includes interior threads 306 to enable the lid to be screwed onto the exemplary body 100 depicted in FIGS. 1-2. In this manner, the body and the lid form a water-resistant enclosure for the movement, stem, and crown. In alternative embodiments, the lid 300 may have exterior threads to enable the lid to be screwed together with a body having interior threads. The degree of water resistance provided by the body and lid when screwed together may depend on the specific materials and thread granularity used to manufacture the lid and body, and on how the threads are sealed. In some embodiments, additional water resistance may be achieved using rubber gaskets in the interior of the watchcase.

In alternative embodiments, as described earlier with respect to body 100, the lid may not include threads, and instead may be mated with the body by snapping together, by mechanical interlock, or by other suitable approaches. In some embodiments, the lid and the body may be joined by a hinge. In embodiments where the notch 110 of the body 100 extends through the wall 104 to form an opening, the movement, stem, and crown are still enclosed when the watchcase is assembled by mating the lid 300 with the body 100.

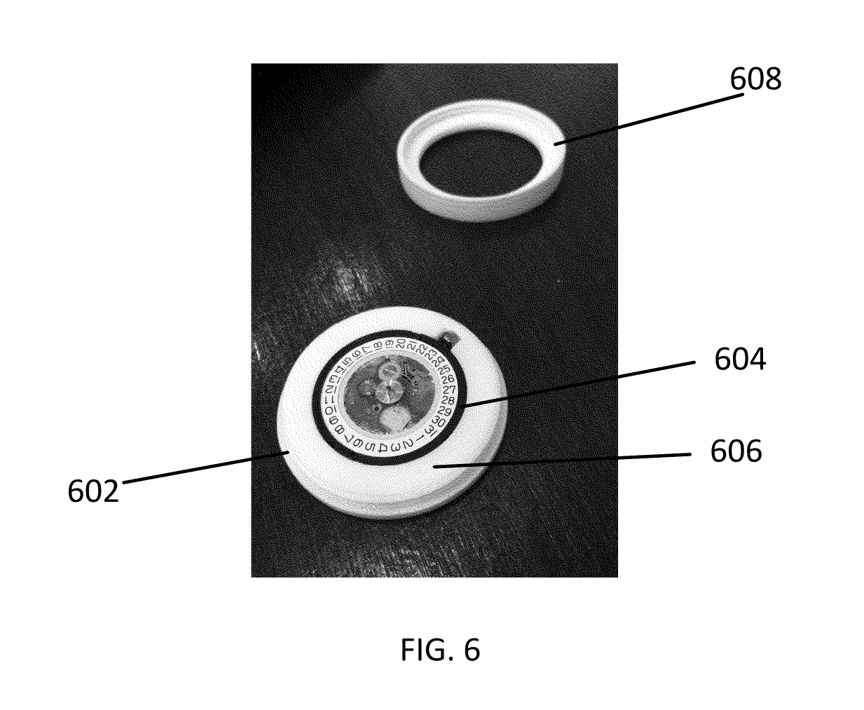

FIG. 6 depicts a body 602 and a lid 608 of an exemplary watchcase. A movement, stem, and crown are installed in the body 602. The black ring 604 is part of the movement and cannot be removed, and has an opening for the stem. The geometry of the wall 606 may be chosen such that the movement, stem, and crown fits securely within the body. The lid 608 may be screwed onto the body 602 to form a watchcase enclosing a movement, a stem, and a crown. When the watch is assembled, a dial will be placed on top of the movement, stem, and crown assembly, with an opening in the dial that is aligned to lie over the crown to allow access to the crown through the dial.

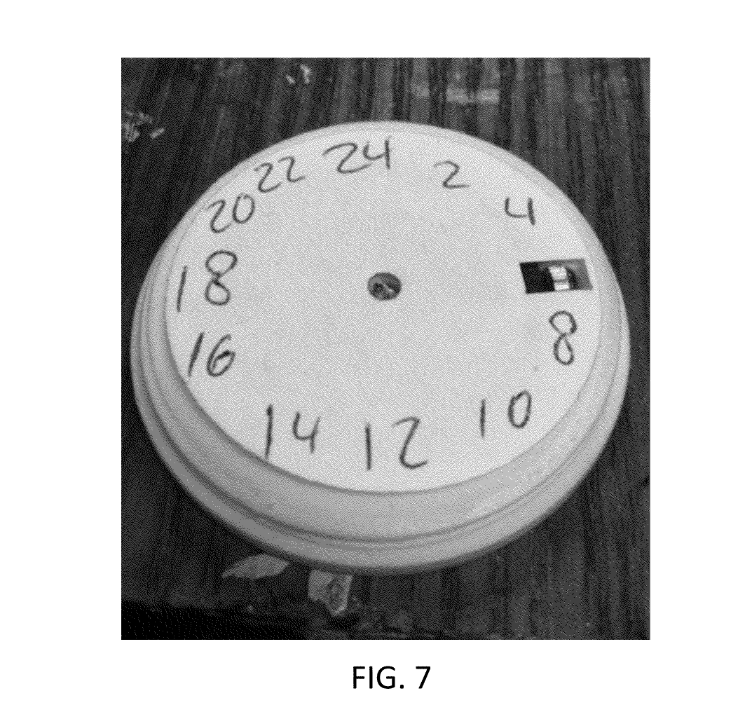

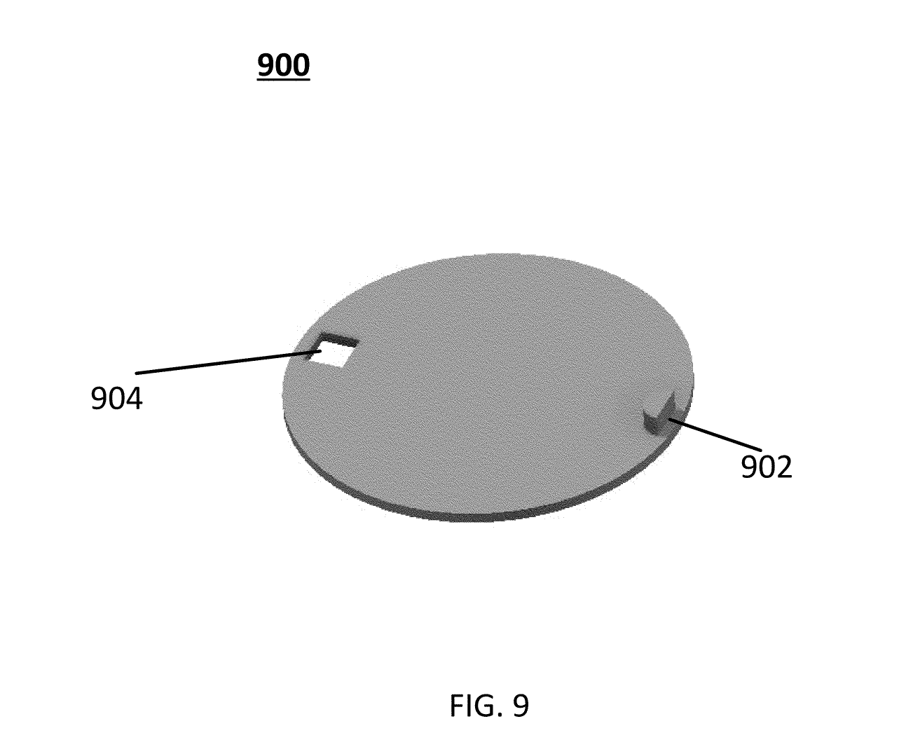

FIG. 7 depicts a watchcase body with an exemplary dial installed over the movement, stem, and crown assembly. As shown in FIG. 7, the crown is accessible through an opening in the dial. The crown protrudes above the dial, thus allowing it to be manipulated by pushing, pulling, and rotating. In FIG. 7, the dial is shown with a 24-hour timekeeping display. In alternative embodiments, the dial may have a 12-hour display, or other numbered or non-numbered display. In some embodiments, the dial may be secured to the body using a peg on the back of the dial that is inserted into a corresponding indentation on the body, as depicted in FIGS. 8-9.

FIG. 8 depicts an exemplary body 800 with a D-shaped indentation 802 in the top surface of the wall. The indentation 802 is designed to accommodate a D-shaped peg attached to the underside of a dial, such that the peg is inserted into the indentation 802 when the dial is installed. In this manner, the dial is held securely in place and is less vulnerable to motion or damage when the watchcase is opened. In alternative embodiments, the indentation may be another shape, such as circular, rectangular, or other geometry.

Exemplary body 800 also has an opening 804 that penetrates through the body 800 to allow a strap or other feature to be threaded through the body 800.

FIG. 9 depicts an exemplary dial 900 that may be used with a watchcase that encloses a movement, a stem, and a crown. The dial 900 has a D-shaped peg 902 that may be inserted into an indentation in the body. In alternative embodiments, the peg 902 may be another shape, such as circular, rectangular, or other geometry. The dial 900 has an opening 904 through which the crown and stem may be accessed when the dial is installed in the watch.

In some embodiments, the watchcase may be configured such that the threads do not cross the level of the movement and therefore, do not cross the level at which a stem and crown would be attached to the movement. In such embodiments, the threads may be above the movement, below the movement, or both.

In some embodiments, the watchcase is formed of a body having a first set of threads above the level of the movement and a second set of threads below the level of the movement, a lid with threads that is configured to mate with one side of the body, and a back piece with threads that is configured to mate with the other side of the body.

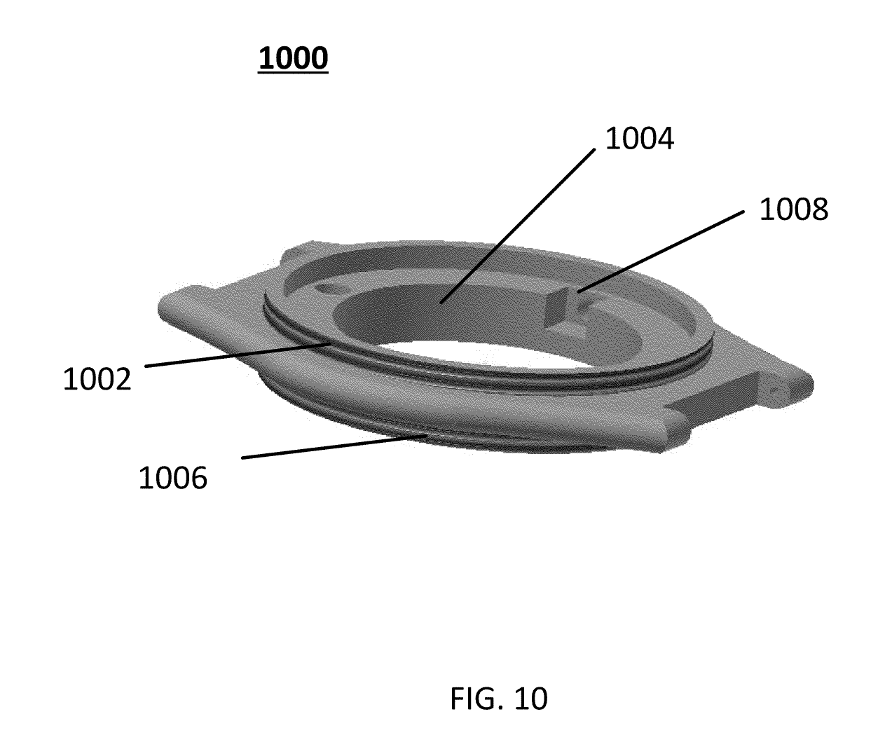

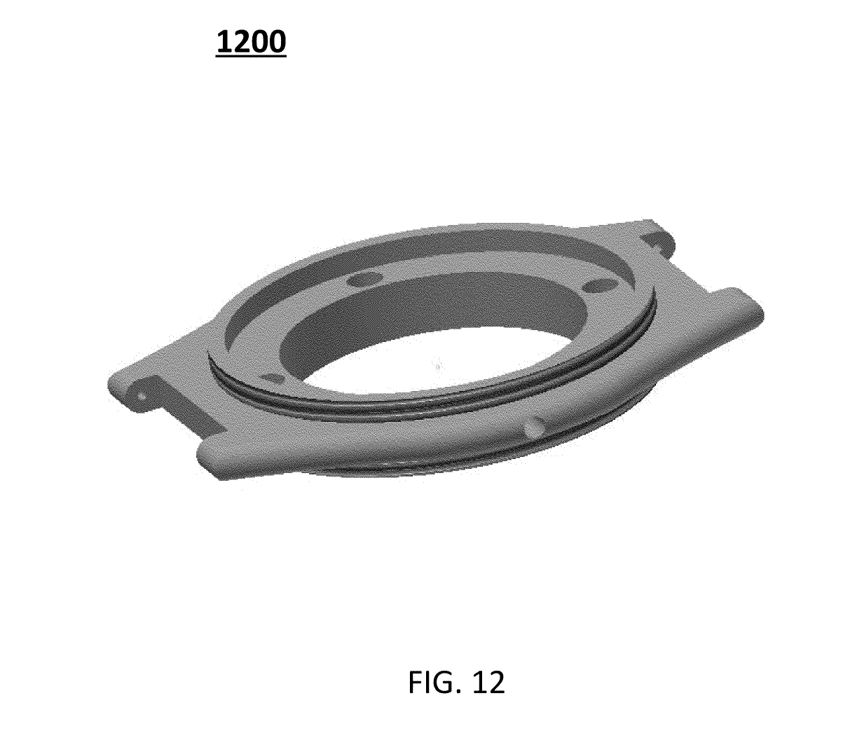

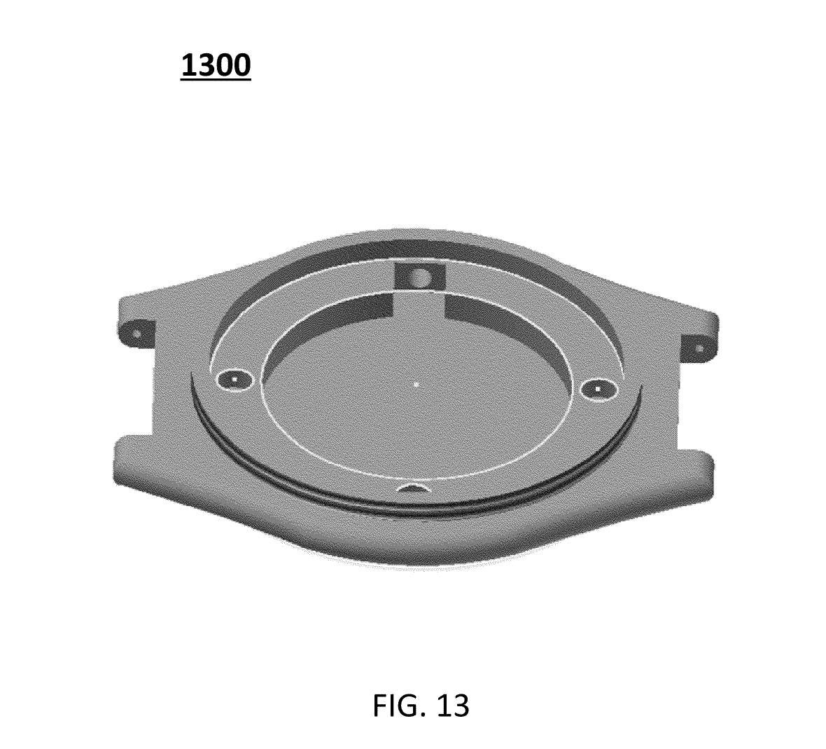

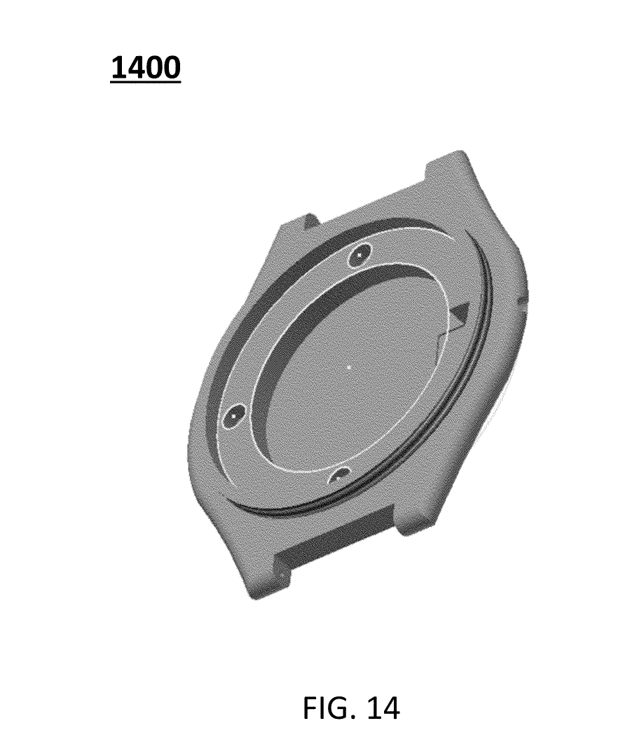

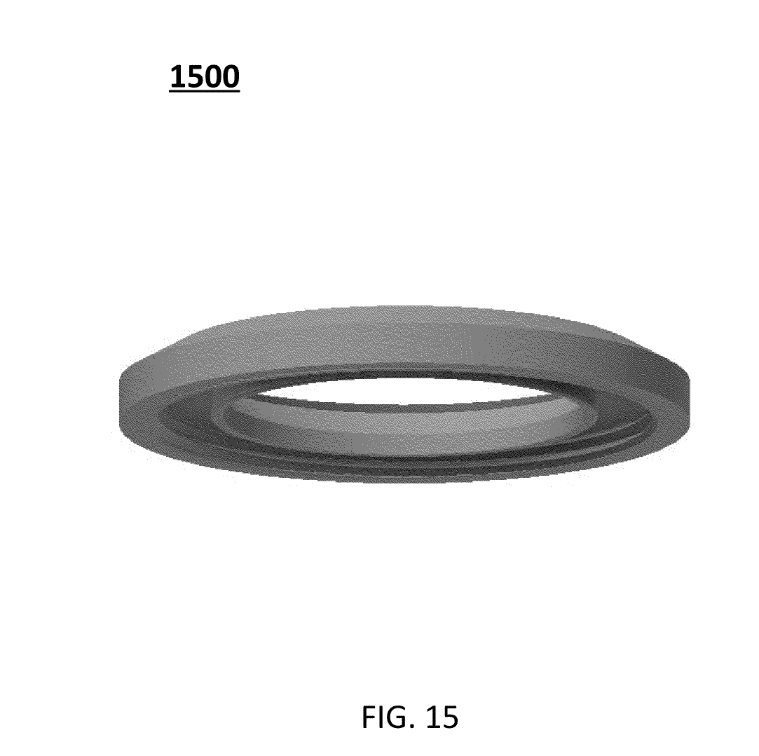

FIG. 10 depicts an exemplary body 1000 with a first set of threads 1002 that are located above the level of the movement and above the wall 1004, and a second set of threads 1006 that are located below the level of the movement and below the wall. As shown in FIG. 10, there are no threads at the level of the movement. FIGS. 12-14 depict alternative views of body 1000. FIG. 15 depicts a lid 1500 that may be used with body 1000.

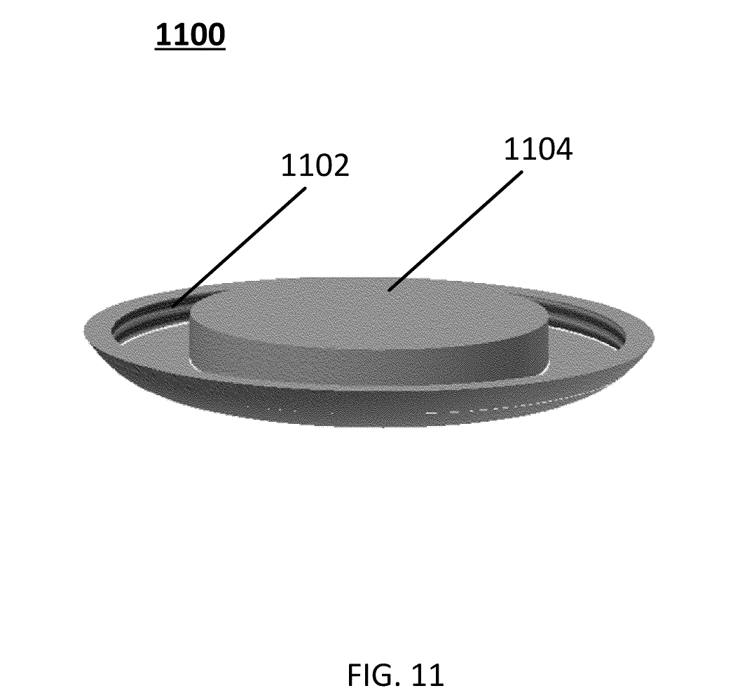

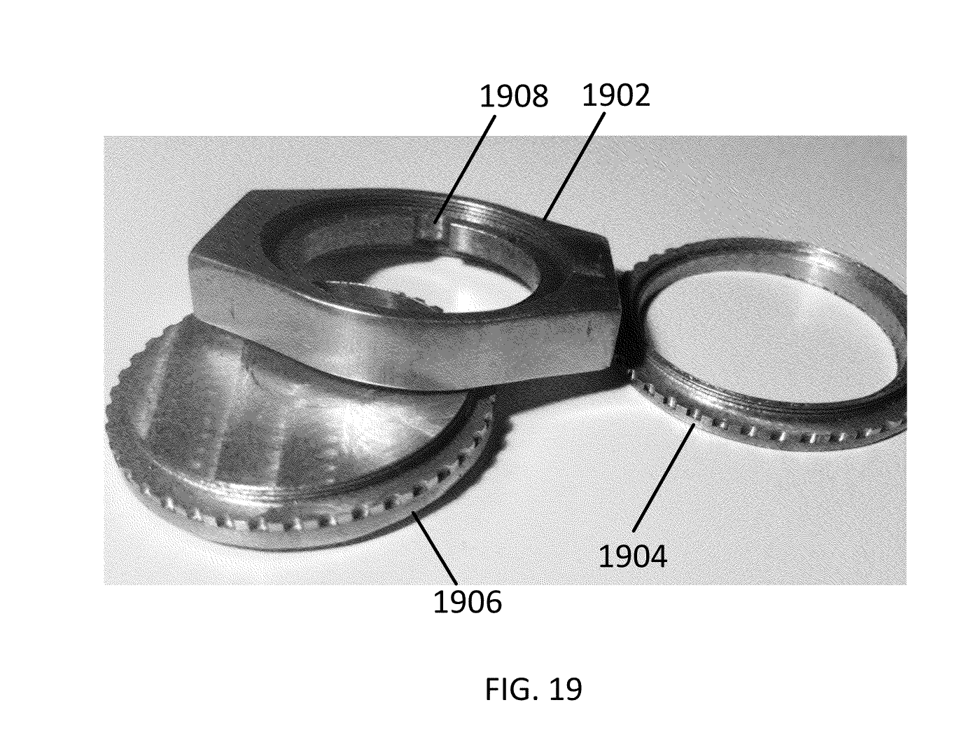

FIG. 11 depicts a back piece 1100 that includes interior threads 1102 for mating with body 1000 and a floor 1104 for supporting a movement. The back piece 1100 is configured to mate with one side of body 1000, while a lid mates with the other side of body 1000, such that the three pieces together can enclose the movement, stem, and crown. FIG. 19 depicts a body 1902, lid 1904, and back piece 1906 that may be assembled to form a watchcase. In body 1902, the notch 1908 allows the crown to be accessed from either the top or the bottom of the body.

In the embodiments depicted in FIG. 10 and FIG. 19, because there are no threads at the level of the movement, at least a portion of the notch 1008, 1908 for the crown may be extended through the body to form an opening if desired, such that the stem can protrude through the body and the crown can be accessible from the exterior of the watchcase. Thus, these embodiments may be used either for a watch with an enclosed crown (if no opening is made) or a watch with an exposed crown (if an opening is made). Similarly, a two-piece watchcase formed of a body and lid in a manner similar to that described with respect to FIGS. 1-4 (that is, with no back piece) but having threads that are only above the level of the movement may also be used either for a watch with an enclosed crown (if no opening is made) or a watch with an exposed crown (if an opening is made).

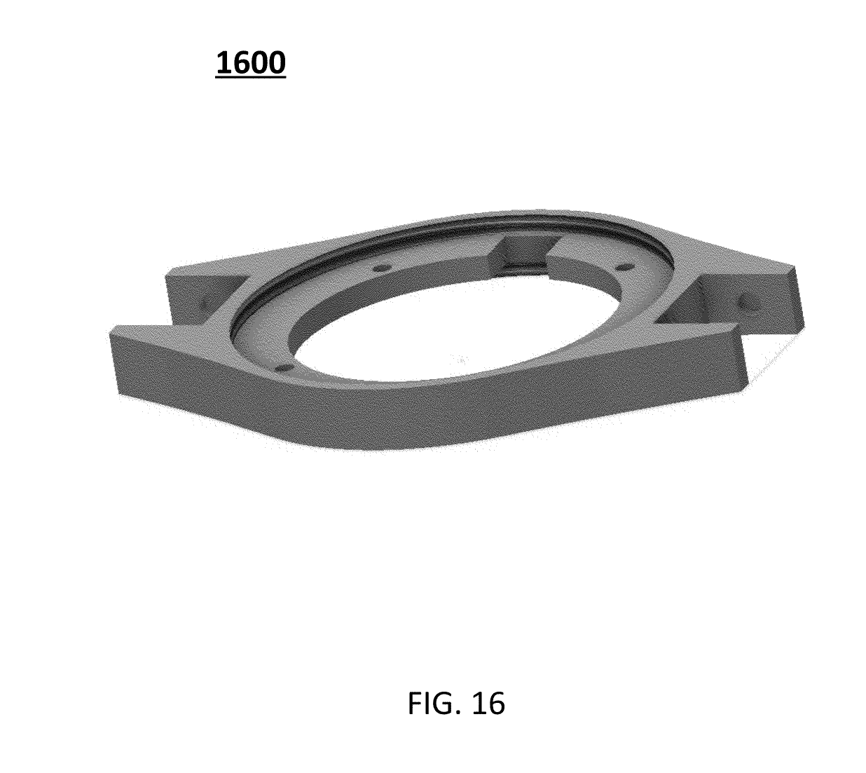

FIG. 16 depicts a body for a watch with an enclosed crown, having interior threads rather than the exterior threads depicted in FIG. 10. FIG. 16 may be mated with a lid and back piece having exterior threads rather than the interior threads depicted in FIG. 11.

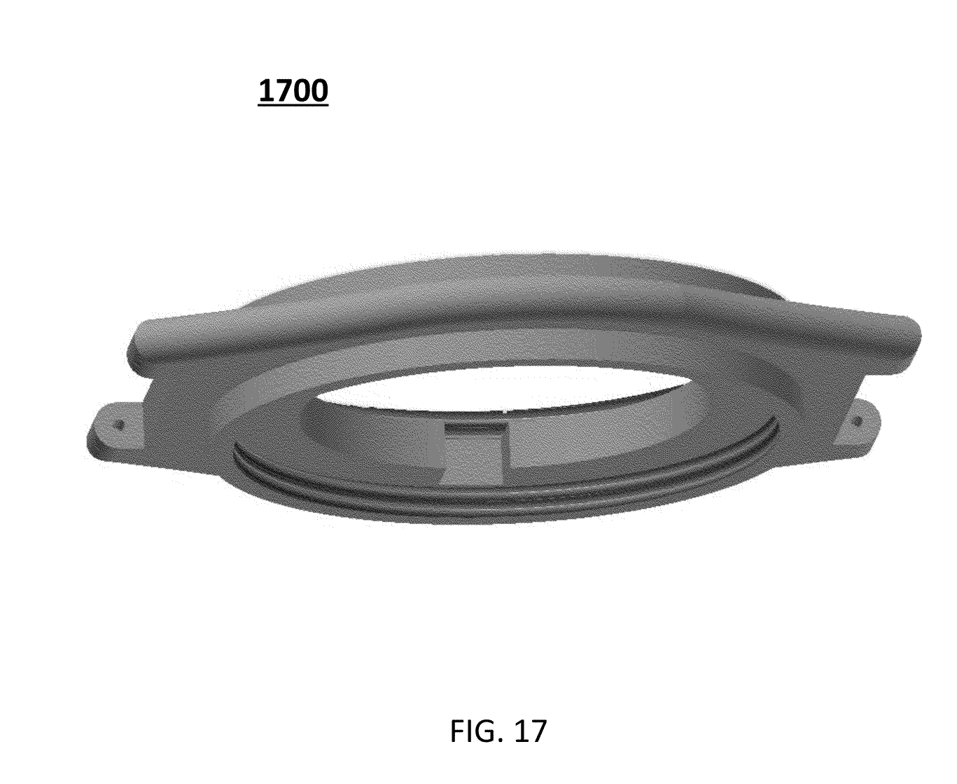

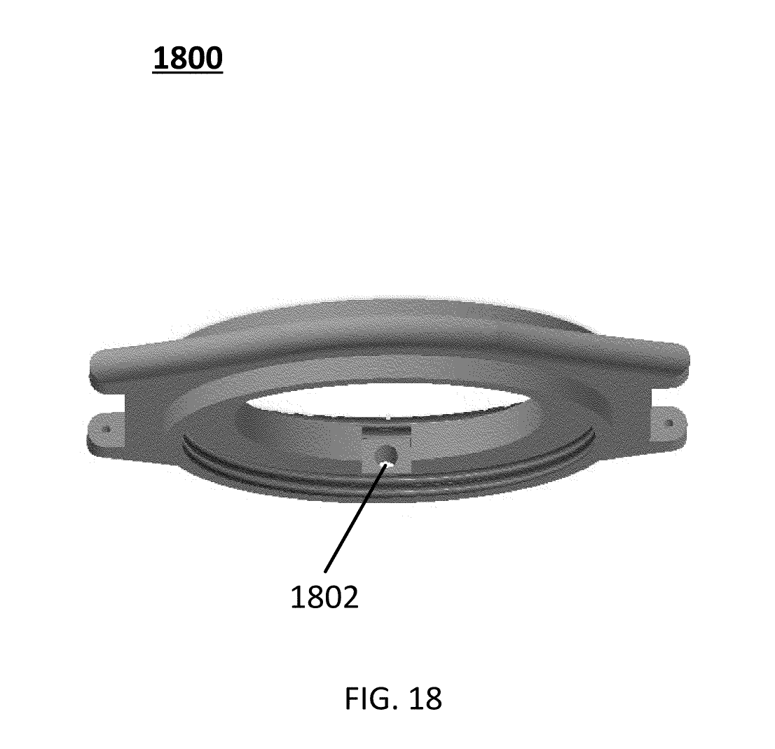

FIG. 17 depicts a body for a watch with an enclosed crown, while FIG. 18 depicts the same body with an opening 1802 drilled for a watch with an exposed crown.

The watchcases depicted in FIGS. 10-11, 15, and 19 can allow access to the crown from either side of the dial, since both the lid and the back piece can be removed from the body. Removing the back piece may also allow relatively easy access to the battery for replacement.

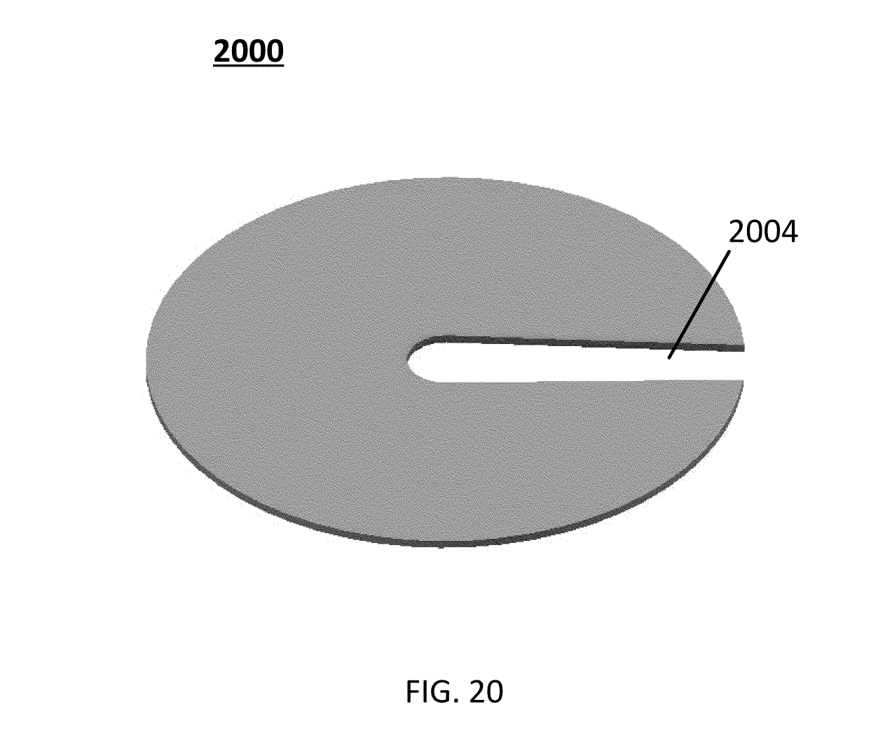

FIG. 20 depicts a dial 2000 for use with a watchcase such as depicted in FIG. 19. In some embodiments, as depicted in FIG. 20, the dial 2000 has an opening 2004 that extends from the edge of the dial to the center of the dial to allow access to the crown. This embodiment allows the crown to be accessed through the dial, and it also allows the dial to removed without removing the hands.

3. Setting the Time on Watch with Enclosed Crown

A method for setting the time on a watch with an enclosed crown using the exemplary body and lid depicted in FIGS. 1-4 is as follows.

The body and the lid are unscrewed to allow access to the crown through a rectangular opening in the dial. The crown may then be extended away from the movement by moving it towards the exterior of the case. The crown may be moved using a finger, for example.

After the stem and crown are extended to disengage the watch hands from the movement, the crown may be rotated to set the position of the hands. This rotation may be accomplished by rolling the crown with a finger, for example, since a portion of the circumference of the crown is accessible above the dial. In some embodiments, the crown may be accessed and rotated from the back side of the dial; that is, from the side of the dial away from the hands. In some embodiments, the time may be set by manually rotating the minute hand. Once the hands are properly set, the crown may be pushed back towards the movement to resume keeping time. The lid may then be screwed back onto the body, forming a water-resistant enclosure for the movement, the stem, and the crown.

4. Materials and Manufacturing

The body and the lid of the watchcase may be manufactured using a variety of techniques. These may include traditional watchmaking processes such as milling, drilling, soldering, and polishing, or newer industrial processes such as metal injection molding, powder injection molding, laser sintering, laser welding, or 3D printing.

The materials used to fabricate the body and the lid of the watchcase may include metals, plastics, ceramics, or other materials with appropriate durability. For embodiments in which the lid and the crystal are fabricated as a single piece, the lid and the crystal may be fabricated of, for example, sapphire crystal, glass, plastic, or other material that provides sufficient durability and visibility. In some embodiments, the lid and crystal may be transparent or translucent. If the lid and the body have threads that enable them to be mated by screwing them together, the threads may be coated with a flexible or adhesive material to provide a better seal and increase water resistance.

For embodiments in which the threads in the watchcase body are located above and/or below the level of the movement, such as depicted in FIG. 10, it may be possible to cut or drill a hole in the side of the watchcase body through which the stem and crown may protrude. By doing so, the hermetic advantages of the watchcase may be reduced, but a user can easily unscrew the watchcase to access the internal components of the watch and set the time by manual rotation of the hands, which may be desirable for some users. Embodiments with threading located above the level of the movement and/or below the level of the movement may therefore be fabricated for use as either a watch with an enclosed crown or, by including an additional step of drilling or cutting a hole, as a watch with an exposed crown.

Although the invention has been described in considerable detail with reference to certain embodiments thereof, other embodiments are possible, as will be understood to those skilled in the art. Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt to a particular situation, material, composition of matter, process, process act(s) or step(s) to the objective(s), spirit or scope of the various embodiments. Further, as will be appreciated by those with skill in the art, each of the individual variations described and illustrated herein has discrete components and features which may be readily separated from or combined with the features of any of the other embodiments without departing from the scope or spirit of the various embodiments.

What is claimed is:

1. A watch for keeping time, the watch comprising:
a movement;
a stem connected to the movement;
a crown connected to the stem;
a watchcase for housing the movement, the stem, and the crown, the watchcase comprising:
a lid having a crystal; and
a body configured to mate with the lid, the body comprising:
a floor that supports the movement; and
a wall surrounding the floor, wherein the wall has a notch into which the crown protrudes; and
wherein the watchcase formed by mating the lid with the body encloses the movement, the stem, and the crown on all sides.

2. The watch of claim 1, wherein:
the lid has a first set of threads;
the wall of the body has a second set of threads; and
the first set of threads and the second set of threads enable the lid and the body to be mated by screwing the lid and the body together.

3. The watch of claim 2, wherein the watchcase formed by screwing the lid and the body together forms a water-resistant enclosure around the movement, the stem, and the crown.

4. The watch of claim 2, wherein the first set of threads are on the interior of the lid and the second set of threads are on the exterior of the wall of the body.

5. The watch of claim 1, wherein at least a portion of the notch extends through the wall to form an opening.

6. The watch of claim 1, wherein the lid and the crystal are a single piece.

7. The watch of claim 6, wherein the lid and the crystal are fabricated from a transparent material.

8. The watch of claim 1, wherein the body and the lid are circularly shaped.

9. The watch of claim 1, wherein the body and the lid are fabricated from a metal.

10. The watch of claim 1, wherein the wall of the body has an indentation into which a peg on a dial is inserted, thereby inhibiting movement of the dial with respect to the body.

11. The watch of claim 10, wherein the indentation is D-shaped.

12. The watch of claim 1, wherein the watch comprises a dial and hands for indicating the time, wherein:
the dial has an opening;
the opening is configured to provide access to the crown for extending the crown away from the movement to disengage the movement from the hands; and
the opening is configured to provide access to the crown for rotating the crown when the crown is extended away from the movement.

13. A watch for keeping time, the watch comprising:
a movement;
a stem connected to the movement;
a crown connected to the stem;
a watchcase for housing the movement and the stem, the watchcase comprising:
a lid having a crystal and a first set of threads,
a back piece having a second set of threads and a floor that supports the movement, and
a body configured to mate with the lid and the back piece, the body comprising:
a wall configured to surround the floor, wherein the wall has a notch into which the stem protrudes;
a third set of threads above a level of the movement; and
a fourth set of threads below the level of the movement,
wherein the first set of threads and the third set of threads enable the lid and the body to be mated by screwing the lid and the body together,
wherein the second set of threads and the fourth set of threads enable the back piece and the body to be mated by screwing the back piece and the body together, and
wherein the watchcase formed by mating the lid, the body, and the back piece encloses the movement on all sides.

14. The method according to claim 13, wherein the watchcase further encloses the stem and the crown on all sides.

15. A method for setting a time on a watch, wherein the watch comprises a watchcase that encloses a movement, a stem, a crown, a dial, and a plurality of hands, the watchcase comprising a body and a lid, the method comprising:
unscrewing the body and the lid from each other;
extending the crown away from the movement until the hands are disengaged from the movement;
rotating the hands or the crown;
moving the crown back towards the movement until the hands are re-engaged with the movement; and
screwing the body and the lid together to form a water-resistant enclosure.
